(19) United States
(12) Patent Application Publication
(10) Pub. No.: US 2006/0165938 A1
(43) Pub. Date: Jul. 27, 2006

(54) Thermal insulating fiberboad with lap or grooved seams

(76) Inventor: Marjan Sircelj, Grosuplje (SI)

Correspondence Address: King & Partners, PLC, 170 College Avenue, SUITE 230, HOLLAND, MI, 49423, US

(21) Appl. No.: 10/512,612

(22) PCT Filed: Apr. 25, 2002
(86) PCT No.: PCT/SI02/00014

§ 371 Date: Apr. 18, 2005

(51) Int. Cl. B32B 3/00

(52) U.S. Cl. 428/57; 428/74

(57) ABSTRACT

The invention involves thermal insulating fiberboard (e.g. made from rock or glass wool) with lap or grooved seams, providing for better overlapping of adjacent boards as well as for better carrying capacity when fitting on the line supports. To get lap seams of a thermal insulating fiberboard it is necessary to glue together two boards (a, b) of identical or different gauges with equal shifting of the alongside and transversal sides of first plate (a) against second plate (b), while a grooved seam is obtained by gluing together three boards (c, d, e) of identical or different gauges with equal shifting of the alongside and transversal sides of one plates (d) against to the other plates (c, e).

The invention involves a thermal insulating fiberboard (e.g. made from rock or glass wool) with lap or grooved seams, providing for better overlapping of adjacent boards as well as for better carrying capacity when fitting on the line supports. The invention has been classified into class E04C 02/50.

The technical problem successfully solved by the proposed version of the thermal insulating fiberboard referred to in this invention involves such version of lap or grooved seam of a thermal insulating fiberboard where due to its structure it is not possible to produce in a simple manner the seams of above shape in the way referred to in the case of thermal insulating boards made from foamy plastics.

As a rule, thermal insulation of peripheral structures of buildings is integrated in the form of thermal insulating boards, made from various heat insulating materials. The manufacture of boards predominantly uses two typical groups of materials with thermal conductivity λ=0.030 to 0.040 W/(m.K), i.e. the so-called foamy plastics, such as foamed or foamy extruded polystyrene, polyurethane and the so-called fiber materials, such as rock or glass wool. In addition to the lowest possible thermal conductivity of the material (product) that together with the involved layers provides for as low as possible thermal conductivity of the boards (“U” value), it is very important that the seams of thermal insulating boards are provided with lap or grooved seams.

With seams of the above shape the contacts between boards may overlap, which results in interruption of the so-called line thermal bridges and mutual interconnection of boards.

A continuous thermal bridge may have negative consequences in terms of transmission, and above all convection thermal losses, such as particularly reflected in the so-called lightweight peripheral structures. To prevent this phenomenon, a lap seam is sufficient, but in view of achieving balanced point or line loads it is very important to achieve an interconnection of boards, which is possible through a so-called grooved seam.

Major problems due to line thermal bridges and disconnection of boards in lateral seams are most frequent in lightweight roof structures, predominantly provided for integration of thermal insulating fiberboards. In this group of products, preference is given to rock wool boards that provide at the same time for low thermal conductivity, for high thermal stability of the structure as well as for considerable carrying capacity.

Glass wool boards have no factory made lap or grooved seams because the fiber structure of the boards is not suitable for milling as it is with boards from foamy plastics.

As already mentioned, milling of both types of seams is typical for thermal insulating boards from foamy plastics. Milling results in partial weakening of the cellular structure of the material, which reduces the strength of the thinned edge of the board and in turn worse standing of the transfer of loads, if the board does not fit on a completely flat base and in particular if the board is only line supported (e.g. when fitting on roof structure carrying beams).

It has turned out in practice that the height of a lap profiled seam is the most reasonable if taking one half of the board gauge. Thereby the thinned part of the board is always evenly loaded. The overlap is supposed to constitute approximately ⅓ to ⅖ of the board gauge, which applies to boards with the gauge exceeding 8 cm. With thinner boards, the overlap constitutes ½ of the board gauge.

With a grooved seam the recess should constitute ⅓ of the gauge, such as applicable to all board gauges—the groove lies in the symmetrical line of the board gauge. In practice, grooved seams are predominantly applied in boards whereof the gauge exceeds 5 cm.

The above lap or grooved seams are possible (including the above deficiencies) with insulating boards from foamy plastics, e.g. foamy or extruded polystyrene or polyurethane, but due to the structure of fiberboards, the same technology cannot be applied for simple production of such seams.

The thermal insulating fiberboard (e.g. from rock or glass wool), such as referred to in this invention, is, however, suitable for both types of seam profiles, i.e. lap or grooved seams, obtained by mutual gluing of several boards with identical indentation of longitudinal or transversal sides. In this way, gluing together of two boards of identical or different gauges while a grooved seam is obtained by gluing together three boards of identical or different gauges results in a board with all four seams profiled as lap seams, while gluing together three boards of identical or different gauges results in a board with all four seams profiled as grooved seams.

The invention will be explained in detail on the concrete example and figures, whereof

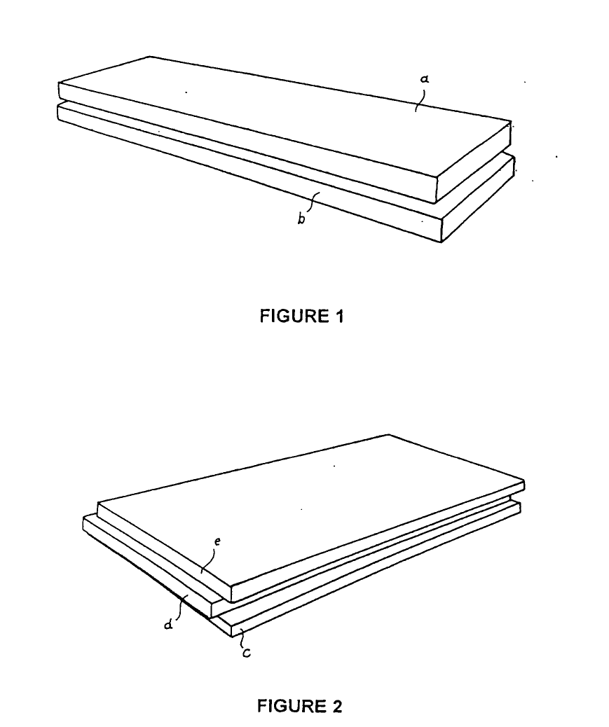

FIG. 1 shows a chart of a glued board, consisting of two fiberboards;

FIG. 2 shows a chart of a glued board, consisting of three fiberboards.

FIGS. 1 and 2 show charts of concrete examples of lap and/or grooved seams. Gluing of two a and b fiberboards of identical or different gauges, such as shown in FIG. 1, with identical indentation of longitudinal and transversal sides of the board a with reference to the longitudinal and transversal sides of the board b, results in lap seams.

Gluing of three c, d and e fiberboards of identical or different gauges, such as shown in FIG. 2, with identical indentation of longitudinal and transversal sides of the board d with reference to the longitudinal and transversal sides of the boards c and e, results in grooved seams.

In addition to the above mentioned interruption, i.e. the line thermal bridges and good interconnection of the boards referred to in this invention, the gluing of two and in particular three boards increases their carrying capacity at fitting on the line supports, such as most often used in practice in the so-called light-weight roof structures.

Practical testing of the version referred to in this invention was subject to the following prerequisites:

Use of thermal insulating fiberboards from high density rock wool (class WD after DIN 18165). This type of fiberboards shows extremely high compressive strength along with high carrying capacity in case of bigger gauges;

Testing of mutual gluing of fiberboards, effected with boards of identical gauges, providing for completely identical seams;

Use of one of the known non-contact construction glues of organic composition, in practice already proven as efficient, resistant, fast and cost effective;

Testing with fiberboards of bigger gauges, that will, glued together, provide for the highest possible carrying capacity.

Until now, this system was most frequently integrated by using rock wool boards in gauges of up to 10 cm, with 150 to 175 kg/m3 density, free of any profiled seams.

First we checked the gluing effect and thereby the lap seam with two 6 cm boards—in total a 12 cm gauge. The boards were of 200/120 cm size, which is the standard size of rock wool boards by a known manufacturer.

The boards were glued together with an identical 6 cm indentation of the longitudinal and transversal sides. In order to provide for an optimum contact between the boards, the two boards were burdened with a continuous load of 0.5 kN. Upon the time foreseen for the effect of the glue, all four sides were provided with 6/6 cm lap seams. The profiled seam was of perfect shape, the lap seam showed the anticipated strength and non-resilience in case of local (straight) load of 0.4 kN per surface of 5×100 cm. The board splitting test showed an extreme splitting strength.

The production of a grooved seam required the gluing of three 4 cm boards—again in total a 12 cm gauge. There was a reciprocal 3 cm indentation of the boards, providing for the same depth of the groove and/or of its corresponding nib. The shaping of all seams provided perfect dimensions, the firmness of the seams was tested on the nib and achieved a practically identical value as in case of testing with a 2×6 cm board.

In order to check the carrying capacity of a glued board the following load tests were performed:

a. Board 2×6 cm

The board was placed on 8 cm wide line supports with 185 cm spacing. The board was subsequently burdened axially symmetrically with 1.8 kN on a surface of 30×100 cm (30 cm crosswise and 100 cm lengthwise). In the center of the board, there was a 3 cm sag.

b. Board 3×4 cm

The test was performed under identical conditions. There was a 1.8 cm sag.

c. Uniform 12 cm Board (Non-Laminated).

is The test was performed under identical conditions as in a., there was a 6.5 cm sag.

With reference to the above results, the gluing of two or three rock wool boards of identical gauges, glued together with specific indentations, resulted in precisely profiled and firm lap and/or grooved seams that provide the required overlapping at integration of boards on different surfaces. Gluing of boards significantly increases their resilience.

1. The thermal insulating fiberboard with lap or grooved seams,
characterized in that
the lap or grooved seams are obtained by reciprocal gluing of two or three boards with identical indentation of longitudinal or transversal sides of one or two boards against each other or against the other two boards.

2. The thermal insulating fiberboard with lap or grooved seams, according to claim 1,
characterized in that
gluing of two (a) and (b) fiberboards with identical indentation of longitudinal and transversal sides of the board (a) with reference to the longitudinal and transversal sides of the board (b) results in a glued board with lap seams.

3. The thermal insulating fiberboards with lap or grooved seams, according to claim 1,
characterized in that
gluing of (c, d, e) fiberboards with identical indentation of longitudinal and transversal sides of the board (d) with reference to the longitudinal and transversal sides of the boards (c, e) results in grooved seams.
